(19) United States
(12) Patent Application Publication
(10) Pub. No.: US 2011/0203417 A1
(43) Pub. Date: Aug. 25, 2011

(54) Magnetic nail punch and countersink device

(76) Inventor: George Roberts Hill, III, Virginia Beach, VA (US)

(21) Appl. No.: 12/932,145

(22) Filed: Feb. 17, 2011

Related U.S. Application Data
(60) Provisional application No. 61/338,827, filed on Feb. 23, 2010.

(51) Int. Cl. B25C 9/00

(52) U.S. Cl. 81/44

(57) ABSTRACT

A magnetic nail punch includes a proximal end and a distal end. A shoulder is arranged between, the proximal and distal ends and protects the user from injury. Magnetic material is arranged substantially near the distal end to hold a nail during installation of the nail.

This present relates to U.S. Provisional Patent Application Ser. No. 61/338,827 filed on Feb. 23, 2010 and claims priority there from.

The subject matter of the present invention did not receive federal government research and development funding.

### TECHNICAL FIELD

Generally, the present invention relates to a nail punch used in conjunction with a hammer and for assisting a carpenter or other user in seating nails into materials that are located in tight spaces where it is difficult to drive the nails. More specifically, the invention is a magnetic nail punch that includes a lip region that protects a user's fingers as the nails are driven into the materials. A hammer strikes the proximal end of the nail punch to drive a nail arranged on the distal end into a material.

### BACKGROUND OF THE INVENTION

There are several types of nail driving devices for assisting one in driving a nail. Some include devices for use in tight spaces or relatively inaccessible places. By way of example, several of these nail driving devices include the following.

U.S. Pat. No. 2,587,944 to Charlie D. Williams discloses an impact tool for use in comparatively inaccessible places. An adjustable, elongated sleeve includes a driving pin. A weighted handle is provided on an opposite end of a shank to the head which may be magnetized.

U.S. Pat. No. 2,624,879 to Frank J. Baird discloses a nail driver for driving fasteners into remote or virtually inaccessible places. A tube is adapted to contain the fattener and operates in conjunction with a magnetized ram.

U.S. Patent Application Ser. No. 2007/0051208 to John W. Stephens discloses a nail driving tool of extended length for use with a standard carpenters hammer having no moving parts is disclosed for the purpose of placing nails in difficult to access places. The tool provides means on a first planar surface for magnetically retaining and holding a plurality of nail types and sizes in proper alignment for positioning. A second planar surface at an opposite end of extended nail driving tool is arranged to further drive said nails to maximum depth.

The aforementioned devices include many complicated parts and or fail to provide and/or fail to provide a device that protects the fingers of the user when the device is used in conjunction with a hammer. To that end, the present invention aims to teach a simple device that includes a protective shoulder region that protects the fingers of the user as the proximal end of the device is struck by a hammer when driving a nail.

### SUMMARY OF THE INVENTION

The present invention is a rounded nail punch or nail set tool having a protective lip arranged substantially near the proximal end thereof. The tool is cross shaped when viewed from the side. The rounded nail punch may be formed from a first piece of round metal stock having a first diameter and a first length. The protective lip may be formed from a second piece of round metal stock having a second diameter that is larger than the first diameter. The protective lip includes a circular opening substantially equal in diameter to the first diameter. The protective lip is fastened substantially near the proximal end of the nail punch via welding or other fastening means. Otherwise, the nail punch may be formed from a single piece of round stock that is machined into the particular shape of the nail punch.

In a preferred embodiment, the overall length of the rounded nail punch is 4¼″ in length from proximal to distal end. The cross section of proximal end of the tool is substantially ⅜″ while the cross of the protective shield or lip diameter is 1⅛″. The overall length of the nail punch is 4¼″ and the length of the protective lip is ¾″. The protective lip or shield is arranged substantially 5/16″ from the proximal end. In a further embodiment, the cross section diameter of the proximal end is ⅜″ while the cross section diameter of the distal end is 9/16″. The tool may also include a canonical end for countersinking fasteners.

It is an object of the invention to teach a simple device for countersinking nails, brads, and other fasteners with ease in tight spaces. It is also useful in toe-nailing frame members, securing plumbing fixtures, installing windows and fences.

It is an additional object of the invention to teach a simplified device for driving fasteners in tight spaces while providing protection for the thumb and fingers of the user.

The above and further objects, details and advantages of the invention will become apparent from the following detailed description, when read in conjunction with the accompanying drawings.

### DESCRIPTION OF THE DRAWINGS

FIG. 1 is a side view of the tool.

FIG. 2 is a perspective view taken from the distal end and showing a rounded insert of magnetic material.

FIG. 3 is a perspective view taken from the proximal end. FIG. 3A is a perspective view of a second embodiment of the invention having a canonical end.

### DETAILED DESCRIPTION OF THE INVENTION

The embodiments of the invention and the various features and advantageous details thereof are more fully explained with reference to the non-limiting embodiments and examples that are described and/or illustrated in the accompanying drawings and set forth in the following description. It should be noted that the features illustrated in the drawings are not necessarily drawn to scale, and the features of one embodiment may be employed with the other embodiments as the skilled artisan recognizes, even if not explicitly stated herein. Descriptions of well-known components and techniques may be omitted to avoid obscuring the invention. The examples used herein are intended merely to facilitate an understanding of ways in which the invention may be practiced and to further enable those skilled in the art to practice the invention. Accordingly, the examples and embodiments set forth herein should not be construed as limiting the scope of the invention, which is defined by the appended claims. Moreover, it is noted that like reference numerals represent similar parts throughout the several views of the drawings.

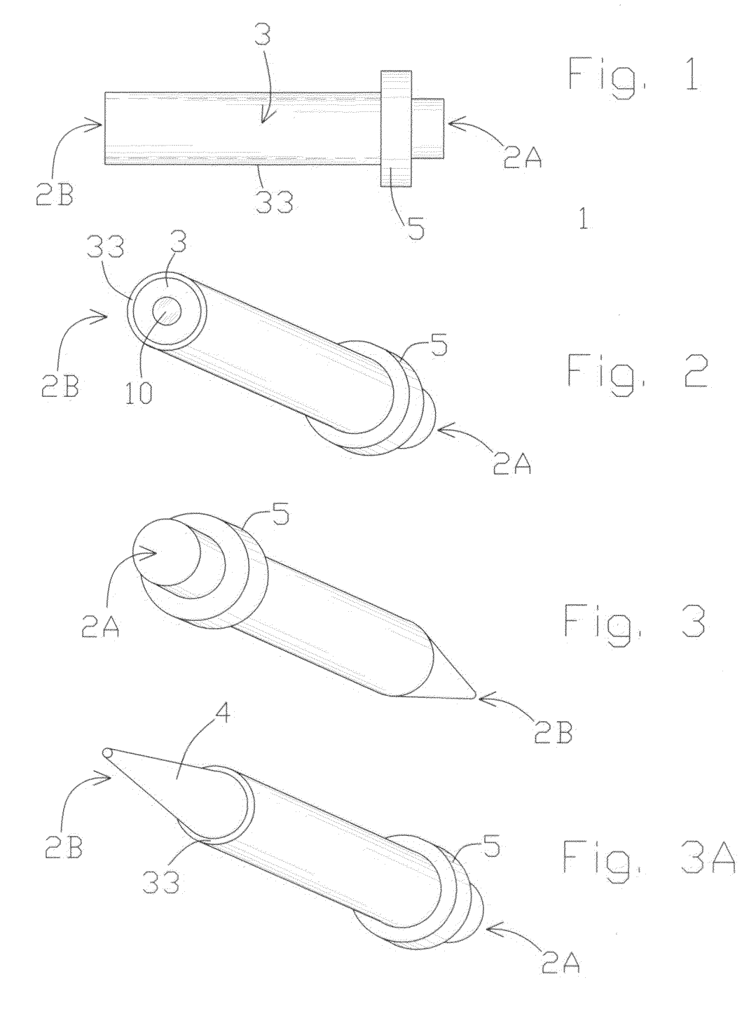

Referring now to the drawings, FIGS. 1-3A depict a preferred embodiment of the invention. In the preferred embodiment, the tool 1 is a rounded nail punch or nail set device having a protective lip 5 arranged around the tool substantially near the proximal end 2A thereof. The tool is t-shaped or cross-shaped when viewed from the side, as shown in FIG. 1. The rounded nail punch may be formed from a single piece of round metal stock 3 having a first diameter being defined at the proximal end. The tool 1 has an overall length defined between the proximal and distal ends of preferably 4¼″. The tool is machined or reduced to include a tapered diameter with the proximal end 2A having the smallest diameter and the distal end 2B having a larger diameter.

The protective lip 5 is formed from a second piece of round metal stock having an interior circle-shaped opening with a diameter that is larger than the diameter of the tool 1 at the proximal end 2A. Otherwise, the tool may be formed from a single piece of round metal stock and turned down through shaving, cutting, milling, or other such metal working techniques. When formed from a separate piece of ring shaped stock, the protective lip includes a circular opening substantially equal in diameter to the diameter of the tool at approximately 5/16″ from the proximal end 2A. In this instance, the protective lip 5 is fastened substantially near the proximal end of the nail punch via welding or other fastening means. The distal end 2B of the round stock 3 may be machined to include an opening into which magnetic material 10 may be arranged.

In a preferred embodiment, the overall length of the tool is 4¼″ in length. The diameter of the proximal end is substantially ⅜″ while the second diameter of the distal end is 9/16″. The distal end may include a diameter of ¼″, ⅛″, 1/16″ and include a rubberized grip to electrically isolate the user. The overall length of the tool is 4¼″ and the length of the protective lip is ¾″ and is arranged substantially at a distance of 5/16″ from the proximal end. The thickness of the protective lip from the inner opening that slips over the proximal end of the tool to the exterior side of the protective lip is ⅜″. That is, the protective lip extends from the outward from the round stock ⅜″ about the exterior of the round stock.

Referring now to FIG. 3A, the tool 1 includes a canonical end 2C that comprises a pointed end 4. The pointed end 4 may be arranged atop a fastener and utilized as a counter-set to countersink the fastener below a surface into which the fastener has been driven. Alternatively, the pointed end 4 may be used for starting a pilot opening or hole into which a fastener or nail is driven. Magnetic material may be included in the pointed end 4 for holding fasteners onto the tool 1 and driving them in tight places. A soft rubber sleeve 33 may be incorporated onto an exterior portion of the tool 1.

While the invention has been described with respect to preferred embodiments, it is intended that all matter contained in the above description or shown in the accompanying drawings shall be interpreted as illustrative and not in limiting sense. From the above disclosure of the general principles of the present invention and the preceding detailed description, those skilled in the art will readily comprehend the various modifications to which the present invention is susceptible. Therefore, the scope of the invention should be limited only by the following claims and equivalents thereof.

1. A magnetic nail punch comprising a piece of metal having:
a rounded proximal head that receives a strike from a hammer;
a rounded shoulder formed substantially near the rounded proximal head; and,
a distal end comprising a magnetic material;
wherein a diameter of the nail punch is uniformly tapered across the nail punch from the rounded proximal head to the distal end such that the rounded proximal head is larger in diameter than the distal end.

2. The magnetic nail punch of claim 1 wherein the distal end is pointed.

3. The magnetic nail punch of claim 1 wherein said distal end is one of a diameter selected from a group consisting of ¼″, ⅛″, and 1/16″.

4. The magnetic nail punch of claim 1 further comprising a rubberized grip that electrically isolates the user.

5. The magnetic nail punch of claim 1 being formed from a single piece of round metal stock.

6. The magnetic nail punch of claim 1 having an overall length defined between the proximal and distal ends of 4¼″.

7. The magnetic nail punch of claim 1 being formed from a piece of metal stock.

8. The magnetic nail punch of claim 1 wherein the distal end comprises a concave shape.

9. A rounded nail set tool comprising:
a body having a proximal end having a first diameter and a distal end having a second diameter and having a protective lip arranged between the proximal and distal ends and substantially near the proximal end of said, said tool is cross shaped when viewed from the side and having an overall length defined between the proximal and distal ends of substantially 4¼ inches.

10. The rounded nail set tool of claim 9 wherein said first diameter is substantially ⅜″ and while the diameter of the protective lip 1⅛ inches and a length of the protective lip is 3/4 of an inch″ and the protective lip is arranged substantially 5/16 of an inch from the proximal end.

11. The rounded nail set tool of claim 9 wherein said distal end is one of a diameter selected from a group consisting of ¼″, ⅛″, and 1/16″.

12. The rounded nail set tool of claim 9 further comprising a rubberized grip that electrically isolates the user.

13. The rounded nail set tool of claim 9 being formed from a single piece of round metal stock.

14. The rounded nail set tool of claim 9 having an overall length defined between the proximal and distal ends of 4¼″.

15. The rounded nail set tool of claim 9 being formed from a piece of metal stock.

16. The rounded nail set tool of claim 1 wherein the distal end comprises a concave shape.
